(19) United States
(12) Patent Application Publication
(10) Pub. No.: US 2026/0017702 A1
(43) Pub. Date: Jan. 15, 2026

(54) Voice Interface Integration System and Method for Mobile, Computer and Web Applications

(71) Applicant: OMNIBEK IP HOLDING LLC, Holmdel, NJ (US)

(72) Inventor: Sergey Bekiyants, Holmdel, NJ (US)

(21) Appl. No.: 19/264,079

(22) Filed: Jul. 9, 2025

Related U.S. Application Data
(60) Provisional application No. 63/668,898, filed on Jul. 9, 2024.

(51) Int. Cl. G06Q 30/0601; G06F 3/16; G06F 40/205; G06F 40/30; G10L 15/22

(52) U.S. Cl. CPC G06Q 30/0629; G06F 3/165; G06F 40/205; G06F 40/30; G06Q 30/0641; G10L 15/22; G10L 2015/223

(57) ABSTRACT

A method for voice-based interaction between a user (e.g., a shopper) and online stores includes capturing an initial voice input from a user and converting the voice input to text. The text is analyzed and initial search terms are created such as product name, product description, product category, product brand name, product manufacturer and retailer. One or more searches are conducted using the initial search terms to identify one or more retailers meeting the search terms. One or more identified online retailers are accessed and searches are executed at the one or more identified retailers, generating search results. The identified online retailers have a user interface allowing purchases of the identified product or item. The search results are returned to the user.

### FIELD OF THE INVENTION

The present invention relates to voice interface integration with mobile, computer (desktop/laptop/notebook) and web applications and in particular methods and systems for integrating voice interfaces with existing mobile, computer and web applications which have but are not limited to clickable graphic user interfaces and user interfaces with text imputable content.

### BACKGROUND OF THE INVENTION

Traditional software applications require users to interact with interfaces through manual inputs such as clicking, typing, and navigating screens. Existing voice assistants such as Apple Inc.'s Siri and Amazon's Alexa provide limited functionality, mostly focused on specific tasks rather than comprehensive interaction with diverse applications. There is a growing need for a system that can seamlessly convert any mobile, computer or web application into a voice-interactive version, providing users with an enhanced, hands-free experience.

Further, traditional software applications that rely heavily on the manual input methods are often cumbersome and inefficient and require navigating through multiple pages might be time-consuming. These methods are especially challenging for users with limited technical skills, vision impairments, or those who need to operate the applications hands-free, such as drivers, professionals, and businesspeople. Existing voice assistants offer limited capabilities and are not integrated into the functionality of individual applications/websites, making them inadequate for comprehensive application control and navigation.

One category of software applications are online shopping platforms. Such online shopping platforms continue to expand. Most online shopping platforms still require users to interact with the platforms using text-based inputs or graphical interfaces. These interfaces can be unintuitive or inaccessible for certain users. Additionally, store owners with online shopping platforms often lack deep insights into their customers' real-time shopping behaviors and evolving preferences.

What is needed in the art is the ability to integrate voice interfaces with existing mobile, computer and websites (web apps) to allow a natural and efficient mode of interaction, using natural language, to enable users to express complex shopping quires or requests in a conversational manner. However, to date, integrating voice interaction with online shopping requires resolving numerous challenges, including product searches, understanding the intent of the shopper, inventory matching and other analytics.

### SUMMARY OF THE INVENTION

The present invention relates to a method and system designed to transform or modify any existing mobile, computer or web application into a humanized, voice-interactive application (app). The method and system may also be used with new mobile, computer or web applications to create a humanized, voice-interactive and an app with integrated voice command interface.

By integrating a specialized software development kit (SDK) during the development phase for mobile/computer apps or using a browser extension for web apps, applications can be navigated and controlled through voice commands.

The present system leverages Artificial Intelligence (AI) to map the application's functionalities, enabling users to interact with the app using natural language. Key features include voice-activated navigation, integration with existing knowledge bases, and enhanced user experience through AI-driven responses.

The present method and system address the limitations of current manual interfaces by providing a more intuitive, accessible, and efficient way for users to interact with software applications, making them intelligent and providing additional analytical tools and insights.

In various alternative forms, the present method and system may be used to enhance a computer user interface including an extension for a web browser and a stand-alone or custom browser.

The system and method is well-suited to enable voice-based interaction between users and online stores or online retailers. It allows users to engage in natural language conversations with a virtual shopping assistant to search for products, ask questions, and make purchases. Key innovations of the present method and system include:
a voice-driven assistant that integrates with online store catalogs,
a product search mechanism combining deterministic filtering and semantic search,
a dual-mode product indexing system (vector and keyword-based), and
a merchant-facing analytics platform that provides behavioral insights derived from conversational data.

An automated content and action scraper for websites and mobile applications in accordance with the present method and system identifies available content and user-interactable functions and stores them in a knowledge graph structure.

The present method and system enables:
users (e.g., shoppers) to perform nuanced searches using natural language,
personalized product recommendations based on conversational context, and
merchants (retailers) to track demand trends and detect gaps in inventory based on voice interactions.

The present invention, in one specific form thereof, is directed to a method for voice-based interaction between a user (e.g., a shopper) and online stores. The method includes capturing an initial voice input from a user and converting the voice input to text. The text is analyzed and initial search terms are created. The initial search terms comprise one or more of the group consisting of product name, product description, product category, product brand name, product manufacturer and retailer. One or more searches are conducted using the initial search terms to identify one or more retailers that have an online presence allowing customers to purchase items that meet the initial search terms. One or more identified online retailers are accessed and searches are executed at the one or more identified retailers, generating search results. The identified online retailers have a user interface allowing purchases of the identified product or item. The search results are returned to the user.

In one specific further form, the method includes capturing a second voice input from a user requesting purchase of one or more items in the search results and converting the voice input to a second text. The retailer is accessed and the user interface identified, prompting the user for making purchases. A purchase is completed for the one or more search result items based on the second text by automatically inputting required information, optimally including text of the user interface prompts from the captured second voice input.

The present invention, in another form thereof, is directed to a method for converting a text-based website, computer or mobile app interface to a voice activated interface. The method includes initiating analysis of a text-based user interface platform. The user interface platform may be a website, mobile app, desktop/laptop/notebook app, kiosk or embedded screens. The user interface includes text prompts or graphic user interface input prompts. User interface (UI) data is collected including retrieving one or more hypertext markup language (HTML) script, application views, accessibility tree and screen shots. The UI data collected is parsed to extract interface components. The interface components may include user interface text, metadata and layout from UI. The interface components are classified. Action items are identified and extracted from the interface components. The action items may include buttons, links, sliders and gestures.

A knowledge graph (structure) is built from the extracted action items and stored in computer memory. The knowledge graph includes the action items extracted and their respective relationships. The knowledge graph is synced with voice automation. The voice automation allows a user to control the previous text-based user interface platform using voice commands.

The present method in one specific form includes the user interface having text which may include titles, labels, placeholders and other metadata The metadata may include semantic tags, accessibility labels and view types.

In one specific further form, the interface components uses heuristic rules of machine learning models in various categories which may include a navigation menu, a content page, an input form and a search interface.

In one further alternative form, identifying and extracting action items from the user interface includes extracting associated semantics. For example, the semantics may include the navigation transitions, layout positions and visibility conditions.

In yet another further form, the knowledge graph includes items extracted and their respective knowledge relationships stored in a graph-based representation. In one specific further form, the items extracted may include screens, components and actions, and their relationships may include navigation, transitions, layout positions and visibility conditions.

### BRIEF DESCRIPTION OF THE DRAWINGS

The present invention will now be described with reference to the figures as follows:

FIG. 1 is a flowchart for a voice shopping assistant in accordance with the present invention.

FIG. 2 is a store integration diagram illustrating a system that integrates with an online platform in accordance with the present invention.

FIG. 3 is another flowchart directed to product search and filtering method in accordance with the present invention.

FIG. 4 is a flowchart directed to a graphic-based search and filtering method in accordance with another aspect of the present invention.

FIG. 5 is a voice-assistant analytics platform system in accordance with the present invention.

FIG. 6 is a flowchart directed to analyzing websites, computer and mobile apps and other digital interfaces to extract data to permit voice integration in accordance with the present invention.

### DETAILED DESCRIPTION OF THE INVENTION

The present method and system provides voice interface integration to mobile, computer and web applications. The method and system provides a robust integration of a voice interface with any mobile, computer or web application, transforming the application into a fully voice-interactive service. This is achieved through the deployment of a specialized software development kit (SDK) that developers can use to map the functionalities of their applications during the development phase or through an external browser extension for web apps. The present system leverages artificial intelligence to understand and interpret user commands, navigate application screens, and execute tasks without requiring manual input. By converting textual and graphical elements into voice-activated commands, the present system provides an intuitive, hands-free user experience. The present method and system significantly enhances accessibility, usability, and efficiency for all users, including those with disabilities and those who need to use the application while performing other tasks.

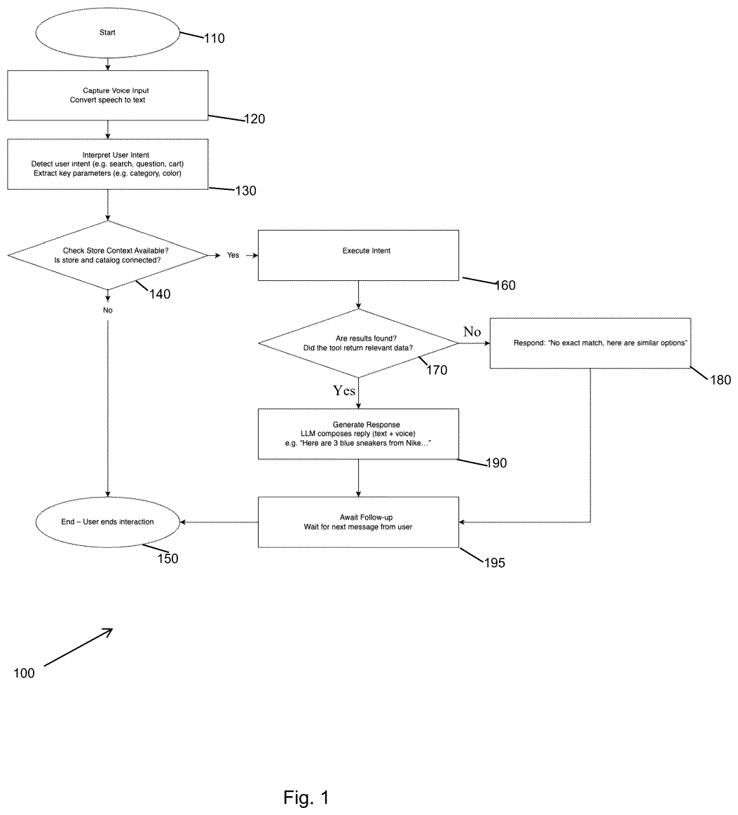

Referring now to the figures and in particular to FIG. 1, voice shopping assistant method 100 is initiated at step 110. A user, such as a customer or shopper, initiates interaction with the present voice assistant through a web, mobile of computer interface (Step 120). It will be appreciated that the present voice assistant is software running on a computer processor. The computer processor can be a remote server or local to a user such as present on a user's mobile device, desktop or notebook computer, etc. The user, using the voice assistant (software), makes a request orally, as a voice input (Step 120). The voice input is captured and the speech is converted to text (Step 120). As is conventional, automatic speech recognition (ASR) may be used to convert user voice input to text (Step 120).

The present voice assistant processes the speech converted to text (i.e., transcribed text) using natural language understanding (NLU) to detect the user's intent, which may be searching for products, asking store-related questions, or managing a shopping cart (Step 130). Key parameters such as product category, color, brand and size are extracted (Step 130).

At Step 130, the transcribed text is processed using a large language model (LLM)-based natural language understanding (NLU) system. The system utilizes a transformer-based LLM (e.g., OpenAI GPT family or other compatible models), capable of both intent recognition and parameter extraction through structured prompting and tool invocation.

In this architecture, user intent is interpreted as the selection or invocation of specific tools, such as:
show_product_description—display information about a product,
search_products—search based on user-specified criteria,
interact_with_store—e.g., request store hours, location, or contact info,
add_to_cart—add a product to the shopping cart, and
checkout—initiate the checkout process.

Unlike conventional NLU architectures that rely on separate intent classifiers and slot-filling models, the present system uses prompt-based reasoning within the LLM to jointly determine both the intended action (i.e., tool) and the relevant parameters (e.g., category, brand, color). These parameters are extracted not only from the current utterance but also by leveraging prior conversational history and external context (e.g., store data).

The LLM is prompted to return structured outputs (e.g., JSON) that include the selected tool name (intent) and key-value pairs (parameters), which are then passed to downstream components for fulfillment.

The conversation is managed as a directed graph, where each node corresponds to a dialog state or decision point. Transitions between nodes are determined by tool invocations, extracted parameters, and predefined state logic. This structure allows for flexible and dynamic dialog flow based on user input and contextual information.

The implementation utilizes the LangGraph framework for managing the dialog graph and orchestrating LLM-tool interactions. This approach supports various backend LLMs and provides robust mechanisms for tracking state, handling ambiguity, and interacting with external APIs or services as tools.

Importantly, while OpenAI models are currently used, the system is designed to be model-agnostic and can be implemented using alternative LLMs, such as Claude, Mistral, Cohere, or open-source models like LLAMA or Falcon.

The voice assistant verifies whether a user is interested in a specific store or retailer and whether that store or retailer has a catalogue that is accessible online (Step 140). If the intended retailer is not available online and/or does not have a store catalogue accessible online, the voice assistant responds with a message indicating that the store is not connected (online) and this initial user request is terminated (Step 150).

However, if the retailer is available online and a store catalogue is accessible (Step 140), based on user intent (Step 130), the voice assistant invokes a relevant tool from the backend services (e.g., search engine, FAQ module, cart handler, etc.) (Step 160).

At Step 160, the voice assistant executes the intent identified in Step 130 by invoking the corresponding tool. Each tool corresponds to a predefined action that may be implemented either within the assistant runtime or delegated to an external system, depending on the nature of the tool.

The assistant maintains a mapping between recognized intent types (e.g., search_products, add_to_cart, show_product_description, etc.) and executable tools. Upon identification of an intent and extraction of the relevant parameters, the runtime system prepares a structured payload (typically in JSON format), which is passed to the tool execution layer.

Tool execution may take several forms:
Backend service call: For example, the search_products tool may invoke a backend API responsible for querying the product catalogue. If the user's request contains structured filters (such as brand, size, price range, or color), these are passed as discrete query parameters. If the request lacks clear structure or uses free-form natural language (e.g., “I need something elegant for a wedding”), the system uses a semantic search module based on embeddings or vector similarity to retrieve relevant products.
Frontend action dispatch: In some cases, tool invocation results in a command being sent to the frontend interface (e.g., to scroll to a product, highlight an element, or navigate to checkout). These are delivered as UI-level instructions, typically using WebSocket messages or structured events.
Hybrid or fallback logic: When the system cannot fully resolve user intent into a precise action, fallback tools may be triggered to request clarification or suggest next steps.

Execution of the tool returns a result (such as a list of products, a confirmation, or an error), which is routed back to the assistant. The LLM then uses this information to construct an appropriate natural language response to the user.

This modular execution model allows for flexibility in defining new tools and integrating them with both frontend and backend components of the voice assistant architecture.

The voice assistant returns results and evaluates whether the results meet the user intent (Step 170). If the exact results are not found (“No”) a user is notified that no exact matches were found but optional alternative items are presented to the user if available (Step 180).

If items are found, a large language model (LLM) generates a natural language response which is delivered to the user as both text and synthesized speech (Step 190).

At Step 190, a large language model (LLM) is used to generate a natural language response to the user, based on the results obtained from backend services and the context of the ongoing conversation. The LLM is responsible for composing a coherent, context-aware reply that may reference the user's original request, search results, prior utterances, or even recent user actions (e.g., clicks or scrolls on the page).

The system currently utilizes an OpenAI model, such as GPT-40 or GPT-40 mini, accessed via API. The architecture is compatible with other transformer-based LLMs offering similar capabilities, including third-party hosted models or future equivalents.

The assistant constructs a prompt based on:
the recognized user intent and extracted parameters (from Step 130),
the structured or unstructured results retrieved by tools (Step 160),
the prior dialogue history (maintained as part of the assistant's internal context),
and any additional metadata (e.g., user actions or preferences).

The prompt is sent to the LLM, which returns a streamed natural language response (i.e., token-by-token or word-by-word generation). This stream is simultaneously passed to a text-to-speech (TTS) module, enabling near real-time vocalization of the assistant's reply. This design ensures minimal latency and delivers a conversational experience that feels immediate and natural to the user.

The TTS system used is 11labs, which supports low-latency, high-fidelity streaming synthesis and is capable of converting partial (incremental) text input into natural-sounding speech in real time. This integration allows the system to begin speaking before the full response is generated by the LLM, thereby improving responsiveness and user experience.

This combined use of streaming LLM output and real-time TTS synthesis provides an interactive experience akin to human dialogue.

The voice assistant can prompt or await a user to provide additional voice input (Step 195). The additional voice input may be to purchase one or more of the items returned. Alternatively, the user may initiate a new search and the flow starts at Step 110.

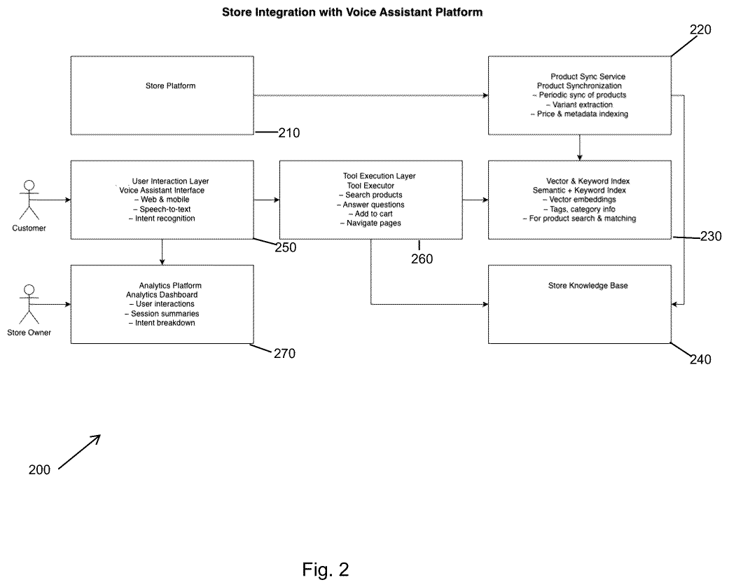

74Referring now to FIG. 2, store integration with voice assistant platform 200 is one exemplary system for implementing aspects of the present voice interface, integration to access online retailers using voice commands. The various modules of system 200 are hosted or executed on an appropriate computer system and/or computer processor and operatively associated with each other as shown and described herein which will be readily appreciated by a person of ordinary skill in the art and therefore not described further here.

The present voice assistant supports integration with various e-commerce platforms 210 such as Shopify and WooCommerce, allowing merchants (retailers) to link to their stores to the present voice integration system. A backend service periodically synchronizes e-commerce data between the e-commerce store platforms 210 and a product sync service module 220. The synchronization between platforms 210 and module 220 includes extracted product variance, prices and metadata and indexing the data for fast retrieval.

Product metadata is processed using NLP to generate semantic embeddings, enable both keyword and vector-based searching using a vector and keyword index module 230.

The backend service responsible for synchronizing e-commerce data from external platforms (210), such as Shopify and WooCommerce, operates in two modes:
1. Initial Import: Upon store integration, the system initiates a full product import using the public API provided by the e-commerce platform. This includes product information, variants, pricing, media, availability, and metadata fields.
2. Incremental Updates: Ongoing synchronization is performed using platform-specific webhooks, which notify the system of updates such as product modifications, price changes, inventory changes, or deletions. Upon receiving a webhook event, the system retrieves the full updated product record and applies changes to the internal data store.

Once data is received, the system extracts relevant fields such as:
Product title, description, brand, categories,
Variants (e.g., size, color),
Pricing, discount status, and inventory,
Media assets (e.g., images, videos).

These fields are then processed to support advanced product search and retrieval.

At module 230, the product metadata is used to create semantic embeddings, combining both textual and visual features. For textual data, NLP models such as BERT, BLIP, or similar transformer-based architectures are applied to product titles, descriptions, and tags. For visual data, models such as CLIP are used to generate vector representations of product images.

The resulting embeddings are indexed in a vector search engine to support semantic search. The current production system uses MongoDB Atlas Search with vector similarity support, enabling hybrid queries combining vector-based ranking and structured filtering (e.g., by store, category, price range). A prototype implementation exists using ElasticSearch, offering more advanced filtering and scoring logic.

At query time, the assistant (via LLM agent) determines:
Which structured filters are applicable for the given store (e.g., brand, price, availability),
What unstructured (semantic) component is present in the user request (e.g., “something elegant for a wedding”).

The agent then constructs a combined query specifying both filter fields and values, as well as a semantic vector for similarity search, and dispatches this to the index module 230.

This architecture enables flexible, real-time product discovery across multiple stores with both precise filter control and high-level semantic understanding.

A knowledge base index module 240 stores knowledge base. The knowledge base includes product metadata and other e-commerce information such as customer FAQs, usage tips, return policies and product guides. The information is stored in a structured form for retrieval by the voice assistant in knowledge base 240.

System 200 also includes a user interaction layer 250. The user interaction layer includes a web-mobile fronted and handles speech-to-text conversion and user intent detection. The user interaction layer 250 allows users to interact with the voice assistant using natural language.

System 200 further includes a tool execution layer 260. The tool execution layer 260 has a central execution engine for various tools including search, cart management, navigation, etc., based on parsed intents.

The tool execution layer 260 is responsible for executing actions based on user intent as parsed and interpreted by the voice assistant. It includes a central execution engine that manages a registry of available tools and dispatches calls to the appropriate tool implementation.

Each tool is registered with:
a unique identifier (e.g., search_products, add_to_cart, navigate_to_checkout),
a specification of required and optional input parameters,
an execution handler, which may be:
an internal function,
a backend API endpoint,
or an interface to a frontend action.

When a parsed intent is received (typically from the LLM), the execution engine resolves the corresponding tool and invokes it with the provided parameters. Tool inputs are structured (e.g., JSON), and validation is performed prior to invocation.

The execution layer supports a variety of tool types, including:
Backend tools that interact with e-commerce services (e.g., search index, cart API),
Frontend tools that control UI behavior (e.g., navigation, highlight, focus),
Knowledge tools that query the knowledge base module (240) for FAQs, return policies, or product instructions.

Execution may be synchronous or asynchronous, and the engine handles timeout logic, fallback handling (e.g., retries, alternative tools), and result routing. Returned results are passed to the response generation layer (LLM), which then formats the output for the user in natural language.

This architecture allows tools to be modular, extensible, and decoupled from the core dialogue logic, enabling seamless addition of new tool capabilities.

Further, the store integration with voice assistant platform 200 has an analytics platform 270. The analytics platform 270 captures and visualizes user engagement data, conversion summaries and trends.

The analytics platform 270 captures, processes, and visualizes user interaction data originating from voice assistant sessions. All user actions—such as product searches, cart interactions, navigation events, and conversational intents—are continuously streamed to the analytics backend via a message bus, such as Apache Kafka.

Each event includes metadata such as session ID, user ID (if known), timestamp, and action type. These events are consumed by a set of processing modules that analyze the incoming data in real time or in batch mode.

The analytics system performs the following operations:
Event aggregation: Tracking and counting user actions (e.g., searches, product views, cart additions, purchases) for each store.
User segmentation and profiling: Classifying users based on observed behavior and conversation patterns. This includes identifying product preferences, intent categories, and behavioral patterns.
Search intent analysis: Aggregating conversational inputs to determine popular search trends, common queries, and unmet user needs.
Persona modeling: Using conversation and interaction data to build buyer personas, including inferred preferences, purchase likelihood, and engagement level.

Processed data is stored in an internal database and made accessible to store owners through dashboards. These dashboards may include visual summaries of user engagement, intent distributions, conversion rates, drop-off points, and trend overviews.

The modular architecture allows different analytics components to plug into the event stream independently. Some modules perform simple aggregations, while others use natural language processing (NLP) to extract deeper insights from conversation logs. The system is designed to be extensible, enabling additional metrics or user behavior models to be added as needed.

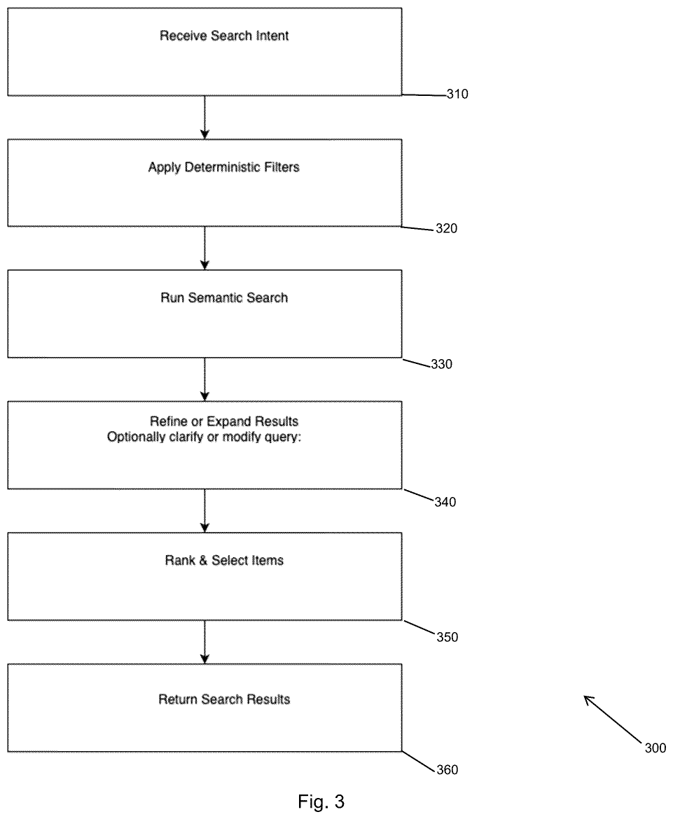

Referring now to FIG. 3, product search and filtering method 300 includes retrieving search intent based on user input (Step 130, FIG. 1) to extract relevant parameters (Step 310). Relevant parameters include search parameters from the query such as category, brand, price, color, style, etc. (Step 310). Deterministic filters are applied such as structured filters to narrow the scope of potential matches for the user's request (Step 320). The filters may be, for example, include Nike, price under $150 (Step 320).

Semantic searches are executed by generating query embeddings and performing nearest, neighbor searches on product embeddings for semantic matching (Step 330). For example, vector embeddings may be used to match semantic meetings, for example “futuristic sneakers”.

In Step 330, semantic search is enabled through the use of vector embeddings that capture the underlying semantic meaning of both user queries and product data. The system generates embeddings for user queries using transformer-based language models that encode textual input into fixed-size vectors. These vectors are compared against pre-computed embeddings of product metadata to identify semantically relevant matches.

Product embeddings are generated by encoding various textual fields, such as product title, description, tags, and optionally visual features extracted from images. Multimodal models such as CLIP or BLIP may be used to generate combined textual and visual embeddings, while purely textual encoders such as BERT or OpenAI's embedding models may be used for lightweight scenarios.

At search time, the user's natural language query (e.g., “futuristic sneakers”) is encoded into a dense vector using the same embedding model. The system performs approximate nearest neighbor search against the indexed product embeddings using similarity metrics such as cosine similarity or dot product to rank the most relevant products.

Embeddings are stored in a vector index optimized for similarity search, such as Faiss, ElasticSearch with vector extensions, or MongoDB Atlas Vector Search. The index allows for fast retrieval of top-k most similar products based on semantic proximity in the embedding space.

This embedding-based search allows the system to retrieve products that are conceptually similar to the user's query, even if exact keyword matches are absent. For example, a query such as “something minimalist and high-tech” can yield results that match style or concept, even if those exact words are not present in the product metadata.

The results are refined and expanded as appropriate (Step 340). The results can also be clarified or search criteria or query modified (Step 340). For example, the results may be refined or expanded for clarity or modification such as “Show me more like this but cheaper” or “Exclude this brand” (Step 340). Further, a user, upon viewing the search results, can use voice commands to request more or alternative items that were previously presented to the user (Step 340).

The search results can be sorted by relevance, popularity, price, stock or other items (Step 350). For example, the products can be sorted by relevance and choose top-N candidates (Step 350).

Finally, the results are returned to the voice assistant to be integrated into a natural language response (Step 360). These results in a natural language, i.e., voice output, are presented to the user (Step 360). The output results are incorporated into the generate response (Step 190) of method 100 (FIG. 1).

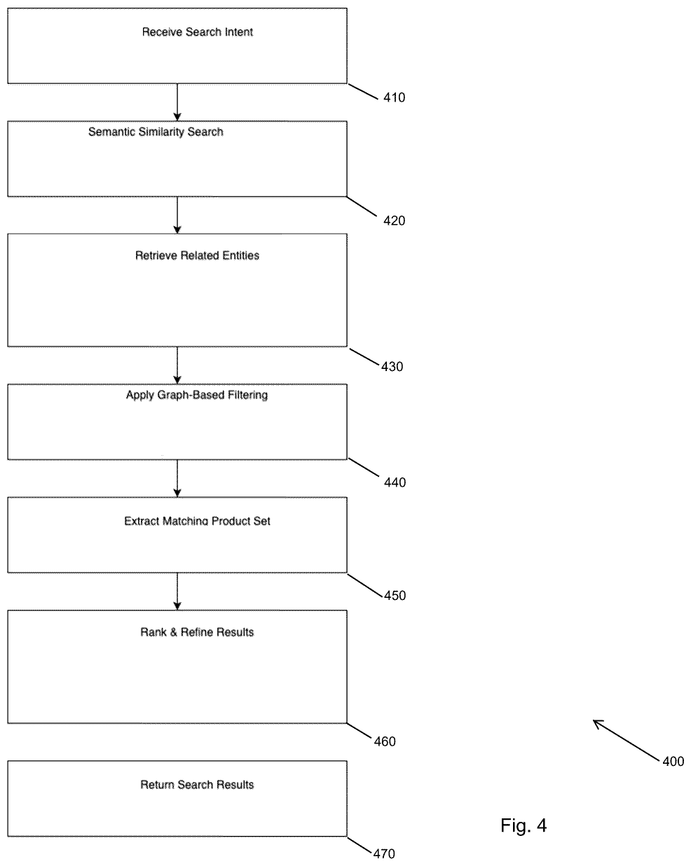

Referring now to FIG. 4, the graphic-based search and filter method 400 is similar to the product and search filtering method 300 but method 400 is directed to a graph-aware context. Accordingly, at step 410, a user search intent is received and the voice assistant extracts parameters from the user's voice query. The parameters extracted may include product category, brand, or various constraints such as “not Nike” or “under $150” (Step 410).

Next, a semantic similarity search (Concept Level) is conducted (Step 420). The semantic similarity search matches the query to graph nodes such as style and product tags via vector embeddings (Step 420).

In Step 420, the user's natural language query is converted into a vector representation (query embedding) using a transformer-based language model, such as OpenAI embeddings, BERT, or a similar model. The system maintains a graph of conceptual nodes, including product tags, styles, and categories, where each node is associated with its own embedding vector, computed from the node's label or description.

The semantic similarity between the query embedding and each node embedding is computed using cosine similarity or dot product. The top-k most similar nodes are selected based on similarity scores. These nodes represent the semantic interpretation of the query and serve as anchor points for building a relevant subgraph. For example, a query such as “futuristic sneakers” may match to graph nodes like “futuristic style,” “techwear,” and “sneakers.”

The graph nodes are used to create a graph structure (Step 420).

Once the semantically relevant nodes are identified, the system constructs a graph structure that reflects the conceptual and relational context of the query. Starting from the matched nodes, the system expands the graph by including connected nodes based on pre-established edges representing relationships such as:
tag-to-brand,
tag-to-category,
tag-to-product,
style-to-product,
product-to-product similarity.

Edges may be weighted based on historical co-occurrence, user interaction data, or semantic proximity. The result is a localized, query-specific subgraph that captures both direct and indirect relationships between concepts relevant to the query. This subgraph forms the basis for further traversal and filtering.

The graph structure is used to retrieve related entities, i.e., items to meet the user's request (Step 430). The graph structure is used to find related brands, categories and attributes (Step 430).

Referring to the retrieval process in more detail, the graph structure is traversed to find:
1. similar brands,
2. related categories/styles,
3. tag-based product groups, and
4. expand candidate product set.

To retrieve related entities, the graph is traversed from the initially matched nodes using breadth-first or weighted traversal strategies. The system performs:
1. Similar brand discovery by following edges from style or tag nodes to brand nodes with high co-occurrence or similarity based on shared product associations.
2. Related categories and styles by traversing from tag or style nodes to neighboring style or category nodes via product co-membership (i.e., styles that commonly co-occur within the same products).
3. Tag-based product group identification by clustering products under shared descriptive tags or functional attributes.
4. Candidate product set expansion by walking from style or tag nodes to additional products not directly connected but linked via shared intermediaries (e.g., related style→shared tag→other product).

Each traversal path is weighted, allowing prioritization of closer or more strongly connected nodes.

Graph-based filtering is applied to the graph structure referred to as pruning graph substructures. The pruning may include filtering based on price, brands and other filters (Step 440).

After the graph is built and traversed, a pruning process is applied to remove irrelevant or low-priority substructures. Graph-based filtering is performed by evaluating node and edge attributes against user-specified or system-deduced filters such as:
price range,
brand preferences,
in-stock status,
store or merchant limitations.

Nodes (e.g., products or tags) that do not satisfy the filter criteria are removed from the graph. Edge connections that lead to filtered-out nodes are also pruned. This ensures that the final graph used for product selection contains only relevant candidates, reducing noise and improving the quality of downstream results.

Products or items which match the user's request are identified by matching products based on graph traversal (Step 450).

In Step 450, the filtered graph is traversed to identify product nodes that best match the user's query. The system uses a scoring algorithm that combines factors such as:
proximity to the original matched nodes,
edge weights along traversal paths,
semantic similarity between the product's embedding and the query vector,
frequency of shared attributes (e.g., common tags or styles).

Traversal continues until a threshold is reached (e.g., number of products or path depth). Products that are reachable through multiple, semantically strong paths are ranked higher. The final product set is selected from terminal product nodes that remain connected after graph filtering and traversal.

The results matched at Step 450 are ranked and refined as appropriate (Step 460). The ranking may be by semantic relevance, popularity, in-stock status, etc. (Step 460). Further, the results can be modified by a user presenting a further voice command such as “Show similar” results (Step 460).

Finally, search results are returned to a user in oral language using the LLM (Step 470). The returned search results may include suggestions on other items which relate or are based on the user's original request (Step 470). These search results are incorporated into the generated response (Step 190) of method 100 (FIG. 1).

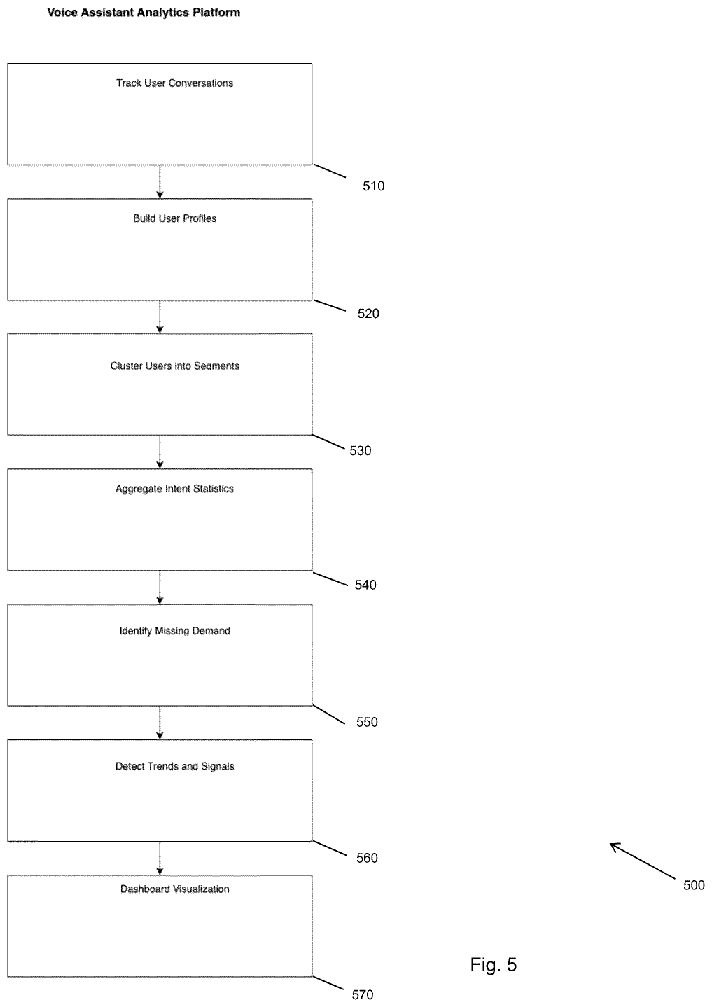

Referring now to FIG. 5, voice assistant analytics platform 500 includes a track user conversation module 510 which logs all user-agent interactions. The track user conversation module 510 includes tracking user-agent interactions such as user quires, assistant replies, intents, and tool invocations.

The track user conversation module 510 captures all messages, tool calls and outcomes, logged and stored in computer memory.

A build user profile module 520 creates and maintains a user profile. The build user profile module 520 analyzes data from a user to infer preferences for the user and builds a user model.

A cluster users into segments module 530 uses an NLP to cluster or categorize users into groups. The cluster users into segments module 530 clusters users into groups based on identified behavior which includes interaction styles presented by the user. For example one behavior may be “budget-focused buyers” as a category of users. This identification allows the cluster users into segment module to cluster users into specific groups.

An aggregate intent statistics module 540 tracks macro-level usage trends and frequently asked quires. The aggregate intent statistics module 540 analyzes individual user's based on the quires of users. Further the intent statics module 540, aggregates metrics, top intents by category, Popular FAQs, Cart Abandonment patents, and Session drop-off points.

Identify missing demand module 550 detects user requests not fulfilled. These may include products not in a catalogue or a retailer not available online. Further, the not fulfilled request may include frequently failed searches of various users. The identified missing demand module 550 highlights quires for products that are not found, helping retailers, i.e., stores or e-commerce sites to adjust inventory.

Detect trends and signals module 560 tracks temporal patterns. The detect trends and signals module 560 observes emerging or changing user interests which includes seasonal changes and trends for various items requested by individuals or users. The detect trends and signals module 560 can track temporal patterns which include interest in brands/styles, new keywords or topics, and other changes.

Dashboard realization module 570 displays analytics data such as voice assistant usage, segments, search trends, missing demand, i.e., items that a user requested but were not returned, and conversational transcripts. The dashboard realization module 570 provides insights to retailers via a web interface with summaries and alerts.

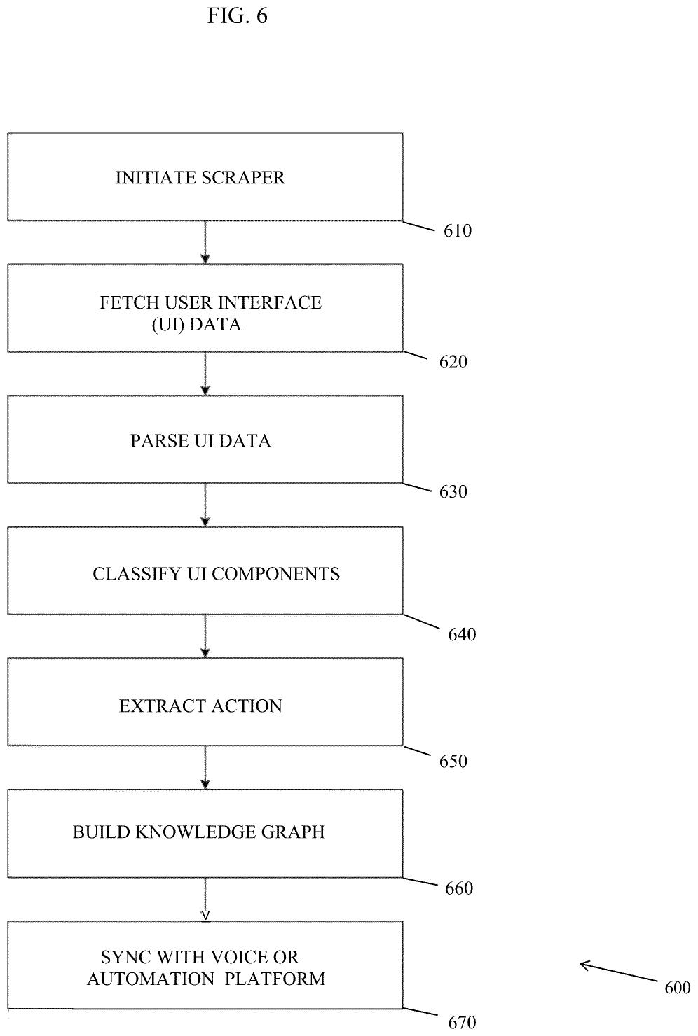

Referring now to FIG. 6, scraper and action extraction method 600 enables the present system to autonomously analyze a wide range of digital user interfaces—including websites, mobile applications, desktop apps, kiosks, or embedded screens—and extract structural and interactive information for downstream use by intelligent agents or automation systems.

A primary function of scraper and action extraction method 600 is to generate a structured, machine-readable representation of an interface, capturing both static content (e.g., page types, text) and dynamic affordances (e.g., buttons, inputs, navigation flows). The extracted interface model is then stored as a knowledge graph, which is utilized by the voice assistant or other agents to understand the interface, invoke valid actions, and respond to user intents, even when interacting with previously unseen systems. The scraper and action extraction method 600 initiates a scraper or scanning routine for a target interface (Step 610).

For example, the target interface can be a mobile or desktop app or a website. The initiation of the scraper can be triggered manually by a user, e.g., a customer, scheduled as part of a monitoring pipeline, or invoked during on-boarding of a new system, e.g., software application (Step 610).

User interface (UI) data is retrieved from the target interface (Step 620). The method 600 collects structural representations of the target interface. For web systems, this includes HTML and CSS content. For mobile or desktop apps, it may include screen hierarchy trees, accessibility views, or runtime screen recordings (Step 620).

Collected virtual representations from the target interface are parsed (Step 630). This includes parsing raw data to extract key user interface features (Step 630). These features include but are not limited to Textual content (titles, labels, placeholders), Metadata (semantic tags, accessibility labels, view types), and UI structure (parent-child layout, z-ordering, regions) (Step 630).

User interface components are classified (Step 640). The classification includes detecting page/view types such as forms, menus, and widgets (Step 640). For example for each screen or view, each is classified using heuristic rules or machine learning modules into various categories such as Navigation menus, Content pages, Input forms, Search interfaces, and Interactive widgets (Step 640).

In Step 640, user interface views are classified into categories such as Navigation Menus, Content Pages, Input Forms, Search Interfaces, and Interactive Widgets. This classification is performed by analyzing rendered web pages using an automated headless browser environment capable of executing scripts and inspecting the Document Object Model (DOM).

The classification process proceeds as follows:

### 1. Full Page Rendering:

A headless browser loads the target web page in a virtualized environment, rendering dynamic content and executing all relevant JavaScript. This ensures that the full, interactive state of the page is available for analysis, including elements that load asynchronously.

### 2. DOM-Based Feature Extraction:

After rendering, a script is executed in the browser context to extract structural and behavioral features from the page. These features include:
The number and type of form-related elements (<form>, <input>, <select>, <textarea>),
The presence of navigational components (e.g., <nav>, top-level link clusters),
The quantity and visibility of clickable elements (e.g., <button>, <a>),
The depth and breadth of the DOM tree,
Positioning, size, and computed styles of UI components,
Semantic cues from element attributes (e.g., class names
like “search”, “menu”, “filter”).

### 3. Classification Logic:

The extracted features are evaluated using:
Heuristic Rules:

For example:
If a page includes more than three input elements within a form→classify as Input Form.
If a <nav> block or list of links appears near the top of the page→classify as Navigation Menu.
If the page contains a labeled search bar or filter panel classify as Search Interface.
Machine Learning Module (optional):

Alternatively, a machine learning classifier may be used to assign the interface type. The model receives a feature vector derived from the DOM and CSS, and outputs a class label. It may be trained on labeled screenshots or structural data from various interface types.

### 4. Result and Integration:

The final classification label is associated with the view and passed to the dialog manager or voice assistant controller. This enables adaptive assistant behavior, such as initiating form-filling when an input form is detected, or summarizing when a content page is encountered.

Actions are extracted including interactive elements such as buttons, sliders, checkboxes, forms, links and gestures (Step 650). The interactive elements are identified and labelled with corresponding or respective action semantics (Step 650). For example, a button labeled “Submit” may be tagged as confirm_action, while a search input may be tagged as query_interface (Step 650).

A knowledge graph is built by extracting entities such as screens, components or actions, with their respective relationships, e.g., navigation transitions, layout positions, visibility conditions, etc. (Step 660). The extracted entities are stored in a graph-based representation (Step 660). The knowledge graph allows the present system to reason about the structure and function of the interface holistics (Step 660).

At Step 660, the system constructs a knowledge graph that models the structure, layout, and behavioral logic of the target interface. This graph enables reasoning about the interface holistically, supporting tasks such as navigation understanding, interaction prediction, and dynamic adaptation.

### Entity Extraction

Entities are extracted by analyzing the rendered web application or page using a headless browser with scripting capabilities. The key entities identified include:
Screens: Distinct views or pages in the interface, often defined by URL routes, major DOM reconfigurations, or root layout containers.
Components: UI elements such as buttons, inputs, sliders, menus, images, or cards. Components are identified by their tag type, role attributes, styling patterns, and interaction handlers.
Actions: Defined user-triggered events, such as button clicks, form submissions, navigation events, or AJAX requests. These are captured by monitoring event listeners, observing changes in the DOM, and analyzing client-side routing mechanisms.

Each entity is assigned a unique identifier and is associated with attributes such as type, label (e.g., from aria-labels or innerText), visibility, bounding box, and interaction metadata.

### Graph Construction

Once entities are extracted, the system builds a graph-based representation where:
Nodes represent entities (screens, components, actions).
Edges represent relationships, such as:
Navigation transitions (e.g., button→leads to screen B),
Layout hierarchy (e.g., menu contains items),
Visibility conditions (e.g., component only shown if input is valid),
Event bindings (e.g., button click triggers action A),
Co-location and proximity (spatial relationships between components).

The graph may include edge weights or labels indicating interaction frequency, user focus patterns, or priority of transitions.

### Graph Usage

The resulting knowledge graph is stored in a queryable graph database or in-memory structure and is used by downstream modules to:
Infer page flow and decision trees,
Generate summaries of screen function,
Predict next user actions,
Guide voice assistant behavior contextually.

This approach provides a structured, machine-readable map of the interface that combines visual layout, behavior, and logic.

The information extracted at Step 660 is synced with a voice or automation platform such as voice and assistant 100 (Step 670). The knowledge graph is synchronized with the runtime assistant or automation platform. This enables real-time interpretation of user intent in the context of the underlying interface. The assistant can decide what actions are valid, how to navigate the UI, or how to respond when asked “what can I do here?” (Step 670).

It will now be clear that the present method and system provides features and advantages not found in prior assistant systems. For example, the present method and system allows use of voice commands instead of text inputs or graphic user selection. This allows for a more natural and intuitive search experience. The present method and system is specifically beneficial for incorporation for e-commerce. However, the present voice method and system can be adapted for use with any text or graphic user interfaces to allow voice commands.

1. A method for voice-based interaction between a user and online stores, the method comprising:
capturing an initial voice input from a user and converting the voice input to text;
analyzing the text and creating initial search terms, said search terms comprising one or more selected from one or more selected from the group consisting of product name, product description, product category, product brand name, product manufacturer, and retailer;
conducting one or more searches using the initial search terms to identify one or more retailers have an online presence allowing customer purchases that meet the initial search terms;
accessing the one or more identified online retailers and executing searches at the one or more identified retailers and generating search results, the identified online retails having a user interface allowing purchases of the identified product or item; and
returning the search results to the user.

2. The method of claim 1, further comprising:
capturing a second voice input from a user requesting purchase of one or more items in the search results and converting the voice input to second text;
accessing the retailer and identifying the user interface prompts for making purchases; and
completing purchase of the one or more search result items based on the second text by inputting required information of the user interface prompts.

3. A method for converting text based website interface to voice activated interface, said method comprising:
initiating “scraping” analysis of text based user interface platform, the user interface platform selected from the group consisting of website, mobile app, desktop app, kiosk or embedded screens, the user interface including text prompts or graphic user interface input prompts;
collecting user interface (UI) data including retrieving one or more of hypertext markup language (HTML) script, application views, accessibility tree and screenshots;
parsing the user UI data collected to extract interface components, the interface components selected from one more of user interface text, metadata and layout from UI;
classifying the interface components;
identifying and extracting actions items from the interface components, said action items selected from one or more of the group consisting of buttons, links, sliders, and gestures;
building knowledge graph from the extracted action items and storing the knowledge graph in computer memory, the knowledge graph comprising the action items extracted with their respective relationships; and
syncing knowledge graph with voice automation, the voice automation allowing user to control the text based user interface platform using voice commands.

4. The method of claim 3, wherein the user interface text comprises text selected from the group consisting of titles, labels, placeholders, and metadata, the metadata comprising data selected from one or more of the group consisting of semantic tags, accessibility labels, and view types.

5. The method of claim 3, wherein the interface components using heuristic rules of machine learning models in categories selected from one or more of the group consisting of navigation menu, content page, input form, and search interface.

6. The method of claim 3, wherein identifying and extracting actions items from the interface components comprises extracting associated semantics.

7. The method of claim 6, wherein the semantics comprises one or more selected from the group consisting of navigation transitions, layout positions, and visibility conditions.

8. The method of claim 3, wherein the knowledge graph comprises items extracted and their respective relationships stored in a graph-based representation.

9. The method of claim 8, wherein the items extracted comprise screens, components and actions and the relationships comprises navigation, transitions, layout positions and visibility conditions.
